(19) United States
(12) Patent Application Publication
(10) Pub. No.: US 2004/0128263 A1
(43) Pub. Date: Jul. 1, 2004

(54) Method for determining pricing

(76) Inventor: Raj Dosanjh, Surrey (GB)

Correspondence Address: HEWLETT-PACKARD COMPANY, Intellectual Property Administration, P.O. Box 272400, Fort Collins, CO, 80527-2400, US

(21) Appl. No.: 10/630,432

(22) Filed: Jul. 29, 2003

(30) Foreign Application Priority Data
Jul. 31, 2002 (GB) 0217782.2

(51) Int. Cl. G06G 7/00

(52) U.S. Cl. 705/400

(57) ABSTRACT

A method of determining a price at which a supplier provides a commodity to a customer, the method being performed by the supplier and comprising: (a) characterising the nature of growth of the customer's usage of the commodity; (b) receiving information from the customer specifying the commodity required; (c) receiving notification of the use of a quantity of the commodity by the customer; and (d) determining a price for the commodity used, the determined price being dependent on the quantity of the commodity used, a level of commercial risk associated with the nature of growth of the customer's usage of the commodity, and an industry average price for the commodity at the time of determination of the price. This method is particularly applicable to the pricing of goods and services in the field of computing and information technology, in particular to items of server infrastructure such as storage capacity and processing capability.

This invention relates to a method for determining pricing. It is particularly applicable, but by no means limited, to the pricing of goods and services in the field of computing and information technology (IT).

### BACKGROUND TO THE INVENTION

A company's infrastructural requirements may well fluctuate according to demand and usage. In the field of IT, for example, demand for hard disk storage capacity and processing capability may increase and decrease over time. Similarly, demand for technical support services may also fluctuate, both in terms of volume and type (e.g. a large scale roll-out or mission-critical support, or relatively small scale support in a test and development environment).

There are several existing methods by which additional IT infrastructure may be purchased by a customer from a supplier. Recently, purchasing mechanisms have evolved to provide “Instant Capacity on Demand” (iCOD) and “pay-per-use” (also known as “utility pricing”) of IT infrastructure.

Typical iCOD infrastructure as purchased by a customer can have a preinstalled amount of storage or processor capacity that is activated and ready to use, and additional storage or processor capacity that is preinstalled for future use but initially deactivated. In the first instance the customer pays for the activated storage or processor components. When, during use, additional storage or processor capacity is required, the customer activates some or all of the hitherto deactivated components and pays the supplier accordingly. The supplier may be automatically alerted by the system (e.g. by e-mail) when the deactivated hardware is brought on-line.

Pay-per-use (or utility pricing) of infrastructure involves the installation of monitoring and reporting software. This software monitors how much of the infrastructure is being used at any given time, and reports its findings to the supplier. The customer is billed for however much storage and processor capacity has been used over a given billing period.

ICOD purchasing mechanisms also exist in which monitoring software as described above alerts the supplier when the storage or processor capacity used has reached a critical value. On receiving such an alert, the supplier delivers and installs additional infrastructure without having had to be explicitly instructed by the customer.

As with infrastructure, additional levels or types of customer support services may also be purchased as and when required. Infrastructure and customer support services may together be referred to herein as commoditized solution elements.

Significant commercial shortcomings are associated with the existing mechanisms for obtaining and purchasing infrastructure and customer support services. Some examples of such shortcomings are as follows, with examples being given from the IT industry:

From the customer's point of view, traditionally it has been faced with commercial risks when considering buying IT infrastructure or support services. Such risks may be classified as being financial, technical or business-related.

Under the category of financial risk, the customer is faced with challenging questions such as “How much infrastructure (people, technology, support, etc.) should be purchased up-front?” If the infrastructure is not used fully then it would be a wasted resource, and money would be lost in the process. However, it is also possible that if insufficient money is invested in infrastructure in advance, then the project might not be as successful as otherwise it might have been had more money been invested up-front.

The issues of resource allocation and outsourcing are also pertinent here. The customer may decide to outsource some resources initially, and then aim to bring them in-house when the project has taken off, its growth has become steady, and the management has become comfortable with the risks involved. Alternatively, if the customer believes certain resources to be mission-critical, it may decide to have them in-house from the outset. Again, these resources could be wasted if the project does not take off as hoped.

Under the category of technical risk questions are asked such as “Is this infrastructure flexible and readily scaleable with the business growth?” Business risks are concerned with such matters as “Will the implementation of this IT application (e.g. a new call centre management system) be successful?” or “Will this new market (e.g. 3G telecommunications) catch on with the public?”

All the above questions are extremely pertinent to the customer. If it cannot predict when it will require additional infrastructure, then it is difficult for it to determine the quantity of infrastructure it should buy in advance. If the customer incorrectly judges (either too high or too low) how much infrastructure to buy in advance, then its costs will not be commensurate with the resulting revenues, and this may be extremely detrimental to the customer's finances and commercial success.

From the supplier's point of view, it has not readily been possible for it to know when (if at all) the customer will require the additional infrastructure or support, and at what rate. This has made it extremely difficult for the supplier to determine an effective and competitive pricing schedule in advance.

Another difficulty concerning growth is that determining competitive pricing may be made difficult because of unpredictable fluctuations in the prices of commodity infrastructure components. This is especially relevant with server and storage infrastructure in the IT industry. The price of a given commodity (e.g. hard disk storage or CPU processing capability) may also vary considerably from supplier to supplier. In order to win the business, trust and goodwill of the customer, it is desirable to be able to offer the customer some assurance that the price they will be charged for additional commodity infrastructure (such as CPU or disk infrastructure) whenever it is required, will be within a certain margin of the industry average at the time. Such an assurance has hitherto been unable to be provided by iCOD suppliers.

It is a general object of the present invention to overcome or at least mitigate the problems, shortcomings and disadvantages associated with the prior art as identified above. Specifically, one object of the present invention is to provide an approach to determining the cost of providing a product or service to a customer, such that the pricing evolves in a dynamic manner in accordance with the growth, and nature of growth, of the customer's business, and such that the pricing is not incommensurate with the industry average for the product or service in question.

### SUMMARY OF THE INVENTION

According to a first aspect of the invention there is provided a method of determining a price at which a supplier provides a commodity to a customer, the method being performed by the supplier and comprising: (a) characterising the nature of growth of the customer's usage of the commodity; (b) receiving information from the customer specifying the commodity required; (c) receiving notification of the use of a quantity of the commodity by the customer; and (d) determining a price for the commodity used, the determined price being dependent on the quantity of the commodity used, a level of commercial risk associated with the nature of growth of the customer's usage of the commodity, and an industry average price for the commodity at the time of determination of the price. This method provides the advantages that the price is tailored in accordance with the risk associated with the growth of the customer's business, and that the commodity is priced at a price commensurate with the industry average at the time.

Preferably the step of receiving notification of the use of a quantity of the commodity further comprises monitoring the customer's usage of the commodity.

If the usage monitoring indicates that the customer has a need for more or less of the commodity, then preferably the method further comprises effecting provision of more or less of the commodity from the supplier to the customer.

Particularly preferably the customer's usage history of the commodity, as monitored by the supplier, is used to dynamically reassess the nature of growth of the customer's usage of the commodity, and hence the associated level of commercial risk. This advantageously results in the continual optimisation of the pricing mechanism used in respect of the commodity, particularly if both backward trends and ongoing forecasts are used to reassess the growth profile.

Preferably the nature of growth of the customer's usage of the commodity is characterised as either constant growth, explosive growth or volatile growth, and accordingly the commodity price is determined using a corresponding level of commercial risk determined respectively as low, high or intermediate.

In the step of receiving information from the customer specifying the commodity required, the commodity may be selected from a plurality of alternatives in the same category of commodity. Preferably the category of commodity is one of a plurality of categories and a selection is made from more than one category, and the alternatives available for selection in each category are modified in response to customer's preference data, or on the basis of previously-selected commodities.

The method may be used for determining the price of commoditized solution elements in the information technology industry. Here, the categories of commodities may include storage capacity, server processing capability, and level of support service required. In such cases, for the commodities of storage capacity or server processing capability, the step of receiving notification of the use of a quantity of the commodity may be performed using monitoring and reporting software or hardware installed on the customer's server.

Particularly preferably the above method is executed using a computer program.

According to a second aspect of the invention there is provided a computer program operable to determine a price at which a supplier provides a commodity to a customer, the computer program being operable to: (a) receive input characterising the nature of growth of the customer's usage of the commodity; (b) receive input specifying the commodity required by the customer; (c) receive input comprising notification of the use of a quantity of the commodity by the customer; and (d) determine a price for the commodity used, the determined price being dependent on the quantity of the commodity used, a level of commercial risk associated with the nature of growth of the customer's usage of the commodity, and an industry average price for the commodity at the time.

Preferably the computer program is further operable to receive data from a remote device specifying the usage of the commodity by the customer.

If the usage data indicates that the customer has a need for more or less of the commodity, preferably the program is operable to effect provision of more or less of the commodity from the supplier to the customer.

Preferably the program is further operable to interpret the customer's usage history of the commodity to dynamically reassess the nature of growth of the customer's usage of the commodity, and hence the associated level of commercial risk.

Preferably the nature of growth of the customer's usage of the commodity is characterised as either constant growth, explosive growth or volatile growth, and accordingly the corresponding level of commercial risk is determined respectively as low, high or intermediate.

Preferably, when receiving input specifying the commodity required by the customer, the commodity is selected from a plurality of alternatives in the same category of commodity. Particularly preferably the category of commodity is one of a plurality of categories and a user makes a selection from more than one category. In such a case the computer program modifies the alternatives available for selection in each category following input of customer preference data, or on the basis of previously-selected commodities. Advantageously, the computer program may be menu-driven, which provides a simple, effective and intuitive user interface.

Particularly preferably the computer program is operable to determine the price of commoditized solution elements in the information technology industry. Here, the categories of commodities may include server storage capacity, server processing capability, and level of support service required. In such cases, for the commodities of storage capacity or server processing capability, the data specifying the usage of the commodity by the customer may be supplied from monitoring software or hardware installed on the customer's server.

According to a third aspect of the invention there is provided a computer program operable to determine a price at which a supplier provides a commodity to a customer, the computer program being stored on a data carrier and operable to: (a) receive input characterising the nature of growth of the customer's usage of the commodity; (b) receive input specifying the commodity required by the customer; (c) receive input comprising notification of the use of a quantity of the commodity by the customer; and (d) determine a price for the commodity used, the determined price being dependent on the quantity of the commodity used, a level of commercial risk associated with the nature of growth of the customer's usage of the commodity, and an industry average price for the commodity at the time.

According to a fourth aspect of the invention there is provided a price determination device comprising a processor operable to implement a method of determining a price at which a supplier provides a commodity to a customer, the method comprising: (a) characterising the nature of growth of the customer's usage of the commodity; (b) receiving information from the customer specifying the commodity required; (c) receiving notification of the use of a quantity of the commodity by the customer; and (d) determining a price for the commodity used, the determined price being dependent on the quantity of the commodity used, a level of commercial risk associated with the nature of growth of the customer's usage of the commodity, and an industry average price for the commodity at the time of determination of the price.

According to a fifth aspect of the invention there is provided a price determination device comprising a processor executing a program to determine a price at which a supplier provides a commodity to a customer, the program being operable to cause the processor to: (a) receive input characterising the nature of growth of the customer's usage of the commodity; (b) receive input specifying the commodity required by the customer; (c) receive input comprising notification of the use of a quantity of the commodity by the customer; and (d) determine a price for the commodity used, the determined price being dependent on the quantity of the commodity used, a level of commercial risk associated with the nature of growth of the customer's usage of the commodity, and an industry average price for the commodity at the time.

### BRIEF DESCRIPTION OF THE DRAWINGS

Embodiments of the invention will now be described, by way of example, and with reference to the drawings in which:

FIG. 1 illustrates a flowchart showing the principal steps of the method in accordance with the present invention, as may be implemented on a personal computer;

FIG. 1a illustrates a series of decisions, each with associated options, that the customer goes through when making its selection of solution elements in Step 2 of FIG. 1;

FIG. 1b illustrates a customer's server providing infrastructure usage data via a digital communications network to the supplier's computer, providing input for Step 3 of FIG. 1;

FIG. 2 illustrates growth in commodity usage with time in accordance with a constant growth profile;

FIG. 3 illustrates growth in commodity usage with time in accordance with an explosive growth profile;

FIG. 4 illustrates growth in commodity usage with time in accordance with a volatile growth profile; and

FIG. 5 illustrates growth in commodity usage with time in accordance with a series of different growth profiles.

### DETAILED DESCRIPTION OF PREFERRED EMBODIMENTS

The method of the present invention provides a means for optimising the pricing of commodities, and is applicable in a general sense to the pricing of many kinds of commodities, irrespective of their commercial field. However, the method of the present invention is particularly applicable to the provision of IT infrastructure (in particular, server storage capacity and server processor capability) and support services.

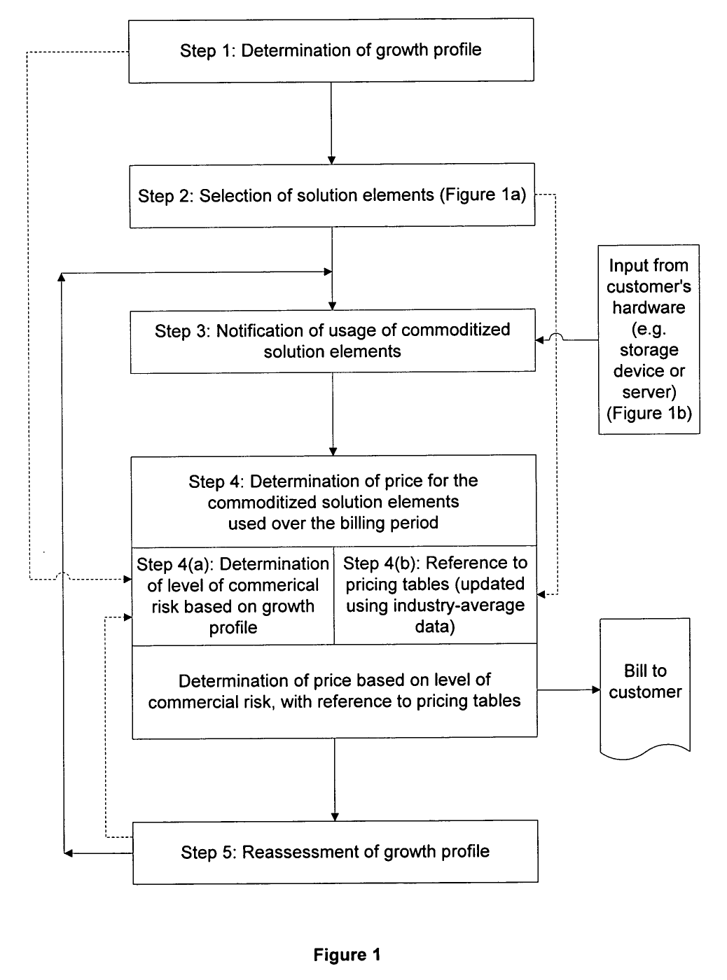

The method of the present invention may be implemented by a computer program running on a standard personal computer (PC). The method involves the following steps, with reference to FIG. 1:

Step 1: Determination of Growth Profile

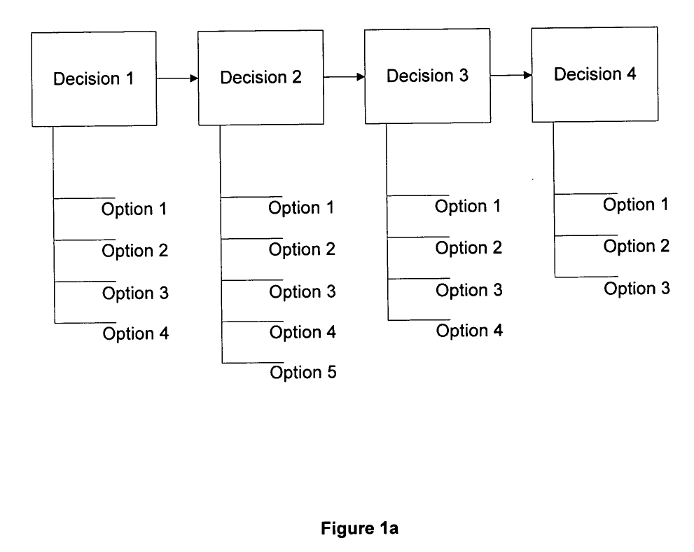

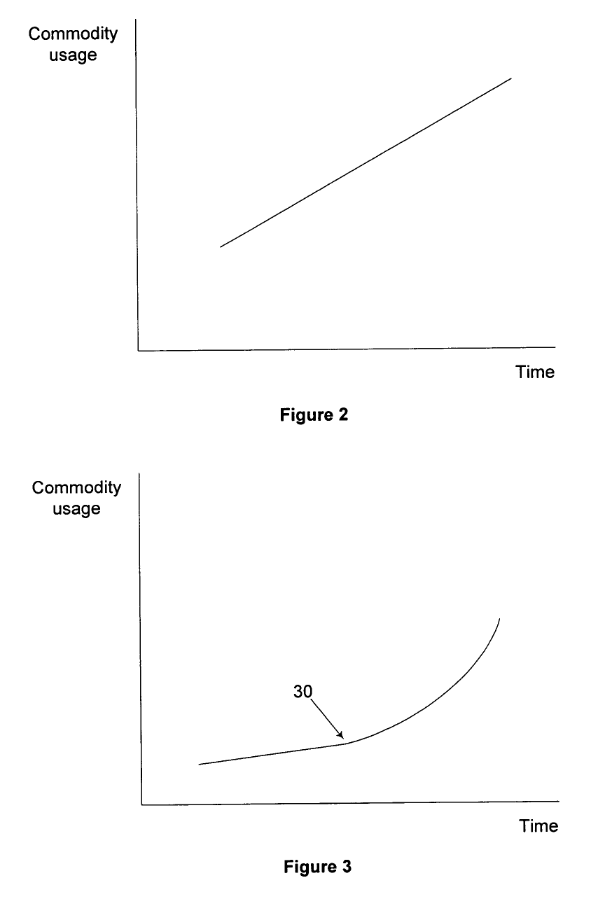

In accordance with the invention, the supplier, preferably in consultation with the customer, determines the growth profile for the usage of (or demand for) the commodity in question, such as storage or processor capacity. Three principal growth profiles have been identified, as illustrated in FIGS. 2, 3 and 4, which show, respectively, constant growth, explosive growth, and volatile growth.

Constant (or “normal”) growth may be experienced in a mature business environment (e.g. a payroll department or a test and development centre), and is characterised by a generally constant growth rate. In such an environment, growth is typically kept within certain constraints by the implementation of low-risk environment management policies, such as archiving or data retention cycles.

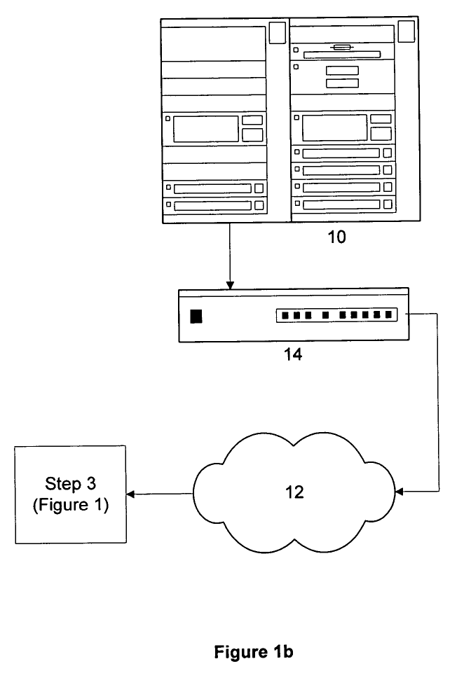

Explosive growth may be experienced, for example, with the take-up of a new telecommunications service such as 3G. As shown in FIG. 3, the growth is characterised by an event 30 (termed a “kicker”) before which growth is slow, but after which it increases dramatically. The kicker may occur at a certain point in time (e.g. when availability or coverage for a mobile telecommunication service reaches a critical level) or after a period of time (e.g. that which is necessary for the public to become comfortable with a new technology). After the kicker, the growth may be largely unpredictable, and may take off in virtually an exponential manner. The point at which the rate of growth begins to flatten out is also unpredictable.

With volatile growth, such as the demand for storage and processor capacity for an e-commerce website, there is an underlying trend 40 (indicated by the dotted line) on top of which fluctuations 42 are observed. The underlying trend is typically strong. The fluctuations in demand may be due to variety of reasons (e.g. Christmas purchases from a website, mergers and acquisitions, or events such as the World Cup) and are generally temporary in nature.

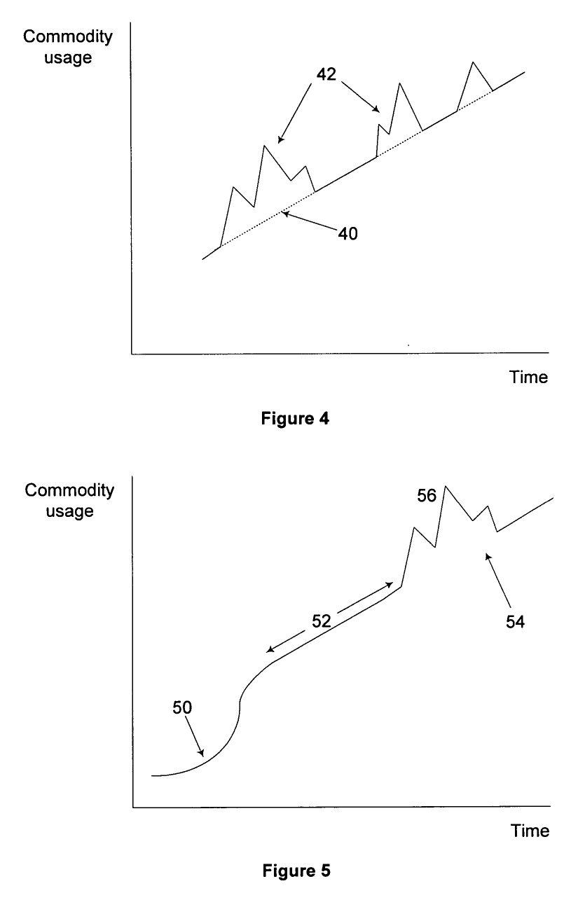

A combination of the above three categories of growth may be observed over an extended period of time, as illustrated in FIG. 5. This shows explosive growth 50 giving way to a period of constant growth 52, followed by volatile growth 54 with spikes 56 occurring in response to promotional events.

Step 2: Selection of Solution Elements

The customer's growth profile having been identified, the customer then provides information to the supplier specifying the details of the required solution elements. These solution elements may comprise some non-commoditized solution elements (e.g. one-off installation services) and commoditized solution elements (e.g. server hardware and support services). In the preferred embodiment of the invention this selection process is carried out via interactive menu-based computer software. With this software the user is prompted to make a series of decisions relating to the customer's business requirements, the commercial criticality of the customer's infrastructure, and the various solution elements available. For each decision the software presents a number of options from which the user can make a selection. Examples of the decisions are as follows:

Decision 1: Geographical location (e.g. UK, Germany, Italy, pan-European)

Decision 2: Criticality of the application (e.g. mission-critical or less so)

Decision 3: Level of support services required

Decision 4: General specification of hardware infrastructure (e.g. enterprise, mid-range or functional)

Decision 5: Specific hardware components (e.g. storage devices and processors)

The software is configured such that the options presented for each decision are modified in response to the user's input in preceding decisions, or in response to preference data supplied by the customer. For example, the criticality of the application as specified in Decision 2 will determine the support options offered in Decision 3 and the hardware options in Decisions 4 and 5. If the application is deemed mission-critical in Decision 2, then the support options offered in Decision 3 and the hardware options offered in Decisions 4 and 5 will be high-end. However, if the application is less than mission-critical, then lower-grade hardware and support will be offered. The number and content of the decision steps themselves may also be modified in accordance with the user's responses.

The menu-based software is intended to be fully scalable and flexible, to enable additional decisions to be added, or decisions to be removed. The options offered with each decision may also be updated or altered as desired.

Step 3: Notifying the Supplier of the Quantity of Commoditized Solution Elements Used

Through a predetermined billing period, quantitative details of the customer's usage of commoditized solution elements are notified to the supplier for billing purposes. This may conceivably be done in a variety of different ways, such as by verbal communication, fax or e-mail.

In the preferred embodiment of the invention, however, this notification procedure is performed automatically by metering/monitoring software and reporting software provided on the customer's server 10 (FIG. 1b). The frequency of the monitoring may be hourly, daily, weekly or monthly, for example. The metering software monitors disk usage by means of the logical units (LUNs) used, and processor usage by means of cycles used. The reporting software notifies the supplier electronically of the details of this usage, via a digital communications network 12 such as the Internet, by way of an automatically-generated e-mail transmission or a coded signal via the network. The transmission may be encrypted using known techniques to ensure that the security of the information is preserved. An example of suitable metering software is Hewlett-Packard's ‘Measureware’ package. Metering and reporting software may be supplied together in a single software package.

Instead of installing monitoring and reporting software on the server or storage device, a hardware device 14 may be connected to the server to perform the equivalent monitoring and reporting functions, transmitting data via the network 12. If the monitoring and reporting software is installed directly on the server or storage device, however, then such a hardware device may not be required and the server 10 or storage device is essentially connected directly to the network 12.

In cases in which additional infrastructural hardware has to be physically delivered to the customer and installed, as and when required, the monitoring and reporting software (or hardware) may also be configured to effect this. A usage threshold may be specified for any given infrastructural element, such that, when this threshold is exceeded, the supplier delivers and installs additional infrastructure without needing to be explicitly asked to do so by the customer. For example, with server storage, the usage threshold may be set to 60%. Accordingly, when the customer has used 60% of the storage capacity of the server, the reporting software automatically notifies the supplier by e-mail that additional capacity is required, and this is then delivered and installed.

Step 4: Determination of Price for the Commoditized Solution Elements Used

(a) Determination of the Level of Commercial Risk

With each category of growth identified in Step 1, and for each different commoditized solution element, it has been found that there exists an associated level of commercial risk. Constant growth equates to low risk, explosive growth carries the highest risk, and volatile growth has associated with it an intermediate level of risk. Different commoditized solution elements may carry different levels of commercial risk. For example, the usage of one CPU (central processing unit) may exhibit low-risk constant growth, whilst that of another CPU may be high-risk explosive growth. Similarly for storage, one volume group of disks may exhibit low-risk constant growth, while another volume group may be characterised by high-risk explosive growth.

Each level of commercial risk has associated with it an optimal purchasing mechanism. The most appropriate purchasing mechanism for low-risk constant growth is buying or leasing infrastructure, because there is little risk and the costs are predictable. Since the risk is low, the associated purchasing costs are low compared with those of the other pricing mechanisms that are to be described below. A key feature of buying or leasing is that pay-as-you-grow or pay-per-use mechanisms can be implemented at any time to augment the initially bought or leased infrastructure. Because the rate of growth in the demand for the infrastructure is known, costs are easily predictable. No unpredictable costs would be expected apart from system upgrades.

With high-risk explosive growth the most appropriate purchasing mechanism is pay-as-you-grow. Here, investment is made only as and when there is demand for additional infrastructure, thereby minimising the risk to the customer. Benefits of this mechanism include a zero capital outlay, and the purchasing being directly linked to the growth in usage of the infrastructure. Immediate scaling is possible. However, the customer will be charged higher costs to reflect the greater risk (to both the customer and the supplier) involved.

In the case of intermediate-risk volatile growth, the most appropriate purchasing mechanism is pay-per-use. As described above there is typically a relatively constant underlying trend underneath the fluctuations, corresponding to a base level infrastructure that is constantly growing. Accordingly, for volatile growth it is possible to use a low-risk buying or leasing purchasing mechanism for the underlying growth, and supplement this with pay-per-use purchasing as and when there are spikes in demand. This ensures that the customer only pays for additional infrastructure as and when it is needed, and only for the duration for which it is required. After each spike, especially in situations where several spikes occur over a very short period, the overall data pool will increase. To ensure that the customer only pays for the spikes, this incremental change to the data pool may be added to the base level infrastructure.

(b) Reference to Pricing Tables to Evaluate the Price of the Specified Solution Elements Used, for the Determined Level of Commercial Risk

With the level of commercial risk having been identified, pre-prepared pricing tables are then used to evaluate the price that the customer is charged for the specified solution elements used over the billing period. For each level of commercial risk, the pricing tables contain unit prices (e.g. price per gigabyte of hard disk storage) for the commoditized and non-commoditized solution elements of infrastructure, as selected by the customer, together with service and support costs and potentially additional premiums in respect of the level of commercial risk involved.

To ensure that the price charged to the customer for commoditized solution elements is within a certain margin of the industry average price at the time, the pricing data in the pricing tables are frequently compared with industry average pricing data (as supplied by IDC or Gartner, for example), and this enables the supplier to ensure that the pricing data is within a pre-determined tolerance (e.g. 5%) of the industry average pricing. If the price of hard disks drops by 30% across the market, say, then the supplier's price to the customer will still be within 5% of this new cost. Trust is thereby built between the customer and the supplier, as the customer is assured that it will never have to pay a price for a commoditized solution element that is incommensurate with the industry average at the time. This also saves the customer time, money and effort, as the customer does not have to continually monitor disk prices etc.

Hence, using the reported usage data for each commoditized solution element over the period monitored in Step 3, its cost is evaluated with reference to the pricing tables. The cost to the customer for all the different commoditized solution elements used are added together, together with any additional costs for non-commoditized elements such as fixed overheads or installation costs. The total cost may then be presented to the customer in a single bill.

Step 5: Dynamic reassessment of the customer's growth profile

The data received by the supplier by way of the monitoring software (or hardware) described above may be interpreted by the supplier to reassess the customer's growth profile for each commoditized solution element. As shown in FIG. 5, a growth profile may change over time from one regime to another, and this may be detected by monitoring the customer's usage history.

As the customer continues to use the commoditized infrastructure, the method essentially loops backs to repeat Steps 3 (notification of usage) and 4 (determination of price). The reassessed growth profile gives rise to a revised commercial risk in Step 4(a), and accordingly the price charged to the customer is also revised.

The customer is thereby assured that, as its business changes and its infrastructural requirement change accordingly, it will not be put at financial risk. Furthermore, the cost for the commoditized solution elements used will always be optimised.

### SUMMARY OF KEY BENEFITS

Directly aligns infrastructure costs and infrastructure support/service costs to business revenues.

Mitigates, if not eradicates, financial risks of purchasing infrastructure and the related support and services when the business outcome or success is not fully understood or guaranteed.

Manages and optimises financial cashflows.

Enables the delivery and management of menu-driven service level agreements to the business by providing a granular and fully costed modular infrastructure and service which is fully scaleable and flexible.

Due to the full scalability and elasticity of the model, each implementation of the model becomes a fully tailored solution for the customer.

1. A method of determining a price at which a supplier provides a commodity to a customer, the method being performed by the supplier and comprising:
(a) characterising the nature of growth of the customer's usage of the commodity;
(b) receiving information from the customer specifying the commodity required;
(c) receiving notification of the use of a quantity of the commodity by the customer; and
(d) determining a price for the commodity used, the determined price being dependent on the quantity of the commodity used, a level of commercial risk associated with the nature of growth of the customer's usage of the commodity, and an industry average price for the commodity at the time of determination of the price.

2. A method as claimed in claim 1, wherein the step of receiving notification of the use of a quantity of the commodity further comprises monitoring the customer's usage of the commodity.

3. A method as claimed in claim 2 wherein, if the usage monitoring indicates that the customer has a need for more or less of the commodity, the method further comprises effecting provision of more or less of the commodity from the supplier to the customer.

4. A method as claimed in claim 2, wherein the customer's usage history of the commodity, as monitored by the supplier, is used to dynamically reassess the nature of growth of the customer's usage of the commodity, and hence the associated level of commercial risk.

5. A method as claimed in claim 1 wherein, in the step of characterising the nature of growth of the customer's usage of the commodity, the nature of growth of the customer's usage of the commodity is characterised as either constant growth, explosive growth or volatile growth, and wherein, in the step of determining a price for the commodity used, the corresponding level of commercial risk is determined respectively as low, high or intermediate.

6. A method as claimed in claim 1 wherein, in the step of receiving information from the customer specifying the commodity required, the commodity is selected from a plurality of alternatives in the same category of commodity.

7. A method as claimed in claim 6, wherein the category of commodity is one of a plurality of categories and a selection is made from more than one category, and wherein the alternatives available for selection in each category are modified in response to customer's preference data, or on the basis of previously-selected commodities.

8. A method as claimed in claim 1 for determining the price of commoditized solution elements in the information technology industry.

9. A method as claimed in claim 8, wherein the categories of commodities include storage capacity, server processing capability, and level of support service required.

10. A method as claimed in claim 9 wherein, for the commodities of storage capacity or server processing capability, the step of receiving notification of the use of a quantity of the commodity is performed using monitoring and reporting software or hardware installed on a server of the customer.

11. A method as claimed in claim 1 executed using a computer program.

12. A computer program operable to determine a price at which a supplier provides a commodity to a customer, the computer program being operable to:
(a) receive input characterising the nature of growth of the customer's usage of the commodity;
(b) receive input specifying the commodity required by the customer;
(c) receive input comprising notification of the use of a quantity of the commodity by the customer; and
(d) determine a price for the commodity used, the determined price being dependent on the quantity of the commodity used, a level of commercial risk associated with the nature of growth of the customer's usage of the commodity, and an industry average price for the commodity at the time.

13. A computer program as claimed in claim 12 further operable to receive data from a remote device specifying the usage of the commodity by the customer.

14. A computer program as claimed in claim 13 wherein, if the usage data indicates that the customer has a need for more or less of the commodity, the program is operable to effect provision of more or less of the commodity from the supplier to the customer.

15. A computer program as claimed in claim 13, further operable to interpret the customer's usage history of the commodity to dynamically reassess the nature of growth of the customer's usage of the commodity, and hence the associated level of commercial risk.

16. A computer program as claimed in claim 12, wherein the nature of growth of the customer's usage of the commodity is characterised as either constant growth, explosive growth or volatile growth, and wherein the corresponding level of commercial risk is determined respectively as low, high or intermediate.

17. A computer program as claimed in claim 12 wherein, when receiving input specifying the commodity required by the customer, the commodity is selected from a plurality of alternatives in the same category of commodity.

18. A computer program as claimed in claim 17, wherein the category of commodity is one of a plurality of categories and a user makes a selection from more than one category, and wherein the computer program modifies the alternatives available for selection in each category following input of customer preference data, or on the basis of previously-selected commodities.

19. A computer program as claimed in claim 12, operable to determine the price of commoditized solution elements in the information technology industry.

20. A computer program as claimed in claim 19, wherein the categories of commodities include server storage capacity, server processing capability, and level of support service required.

21. A computer program as claimed in claim 19, wherein the data specifying the usage of the commodity by the customer is supplied from monitoring software or hardware installed on a server of the customer.

22. A computer program operable to determine a price at which a supplier provides a commodity to a customer, the computer program being stored on a data carrier and operable to:
(a) receive input characterising the nature of growth of the customer's usage of the commodity;
(b) receive input specifying the commodity required by the customer;
(c) receive input comprising notification of the use of a quantity of the commodity by the customer; and
(d) determine a price for the commodity used, the determined price being dependent on the quantity of the commodity used, a level of commercial risk associated with the nature of growth of the customer's usage of the commodity, and an industry average price for the commodity at the time.

23. A price determination device comprising a processor operable to implement a method of determining a price at which a supplier provides a commodity to a customer, the method comprising:
(a) characterising the nature of growth of the customer's usage of the commodity;
(b) receiving information from the customer specifying the commodity required;
(c) receiving notification of the use of a quantity of the commodity by the customer; and
(d) determining a price for the commodity used, the determined price being dependent on the quantity of the commodity used, a level of commercial risk associated with the nature of growth of the customer's usage of the commodity, and an industry average price for the commodity at the time of determination of the price.

24. A price determination device comprising a processor executing a program to determine a price at which a supplier provides a commodity to a customer, the program being operable to cause the processor to:
(a) receive input characterising the nature of growth of the customer's usage of the commodity;
(b) receive input specifying the commodity required by the customer;
(c) receive input comprising notification of the use of a quantity of the commodity by the customer; and
(d) determine a price for the commodity used, the determined price being dependent on the quantity of the commodity used, a level of commercial risk associated with the nature of growth of the customer's usage of the commodity, and an industry average price for the commodity at the time.
